(19) United States
(12) Patent Application Publication
(10) Pub. No.: US 2025/0015315 A1
(43) Pub. Date: Jan. 9, 2025

(54) ELECTROCHEMICAL CELL SYSTEM HAVING A FLOW FIELD PLATE ASSEMBLY FOR REDUCING POROUS TRANSPORT LAYER INTRUSION

(71) Applicant: Twelve Benefit Corporation, Berkeley, CA (US)

(72) Inventors: Adel B Jilani, North Vancouver (CA); Simon Gregory Stone, Arlington, MA (US); John Kreuder, Arvada, CO (US)

(21) Appl. No.: 18/761,949

(22) Filed: Jul. 2, 2024

Related U.S. Application Data
(60) Provisional application No. 63/512,286, filed on Jul. 7, 2023.

(51) Int. Cl. H01M 8/026; C25B 13/02; C25B 13/05; H01M 8/0232; H01M 8/0245

(52) U.S. Cl. CPC H01M 8/026; C25B 13/02; C25B 13/05; H01M 8/0232; H01M 8/0245

(57) ABSTRACT

Various electrochemical cell systems are provided, including various flow field plate assemblies with reinforcement layers that may be particularly useful in the context of fuel cells and electrolyzer cells. Some flow field plate assemblies have a flow field plate (FF plate) having a floor surface and a plurality of raised features protruding from the floor surface, and a support lattice having a plurality of hub portions and a plurality of beam portions interconnecting the hub portions, with at least some of the hub portions being supported by the raised features of the FF plate, and the raised features of the FF plate may be distributed across the floor surface, and the hub portions of the support lattice and the raised features of the FF plate may space apart the beam portions from the floor surface so as to define a flow field depth.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Electrochemical cells may generate electrical energy from the chemical reactions occurring in those cells, or use electrical energy supplied to them to facilitate chemical reactions in them. Examples of electrochemical cells may include electrolyzer cells and fuel cells. Electrolyzer cells offer a potential route for converting or reducing COₓ gas, e.g., CO or CO₂, into one or more desired carbon-based byproducts, such as industrial chemicals or fuels, thereby allowing for waste COₓ gas that would normally be released into the atmosphere to instead be converted into industrially useful products. Electrolyzer cells may include flow field plates having raised features spaced apart from one another to define flow field channels or flow paths. The raised features may further directly engage and support a porous transport layer (PTL). The flow field depth may be based on at least the height of the raised features, and a hydraulic resistance may be based on the flow field channel or flow path depth and the spacing between the raised features, among other features.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY OF THE INVENTION

Details of one or more implementations of the subject matter described in this specification are set forth in the accompanying drawings and the description below. Other features, aspects, and advantages will become apparent from the description, the drawings, and the claims.

A flow field plate assembly may be provided for an electrochemical cell of an electrochemical cell system. The flow field plate assembly may include a flow field plate (FF plate) having a floor surface and a plurality of raised features protruding from the floor surface. The flow field plate assembly may further include a support lattice having a plurality of hub portions and a plurality of beam portions interconnecting the hub portions. At least some of the hub portions may be supported by the raised features of the FF plate. The raised features of the FF plate may be distributed across the floor surface. The hub portions of the support lattice and the raised features of the FF plate may space apart the beam portions from the floor surface so as to define a flow field depth.

In some implementations, the hub portions and the beam portions may be flush on a first side of the support lattice facing away from the floor surface of the FF plate. The hub portions may protrude beyond the beam portions on a second side of the support lattice that contacts the raised features of the FF plate, such that the hub portions act to elevate the beam portions away from the floor surface of the FF plate.

In some implementations, the flow field plate assembly may further include a porous transport layer (PTL). The hub portions and the beam portions of the support lattice may be configured to distribute a load across the PTL and decrease an intrusion of the PTL into the one or more flow fields when the PTL is compressed towards the FF plate.

In some implementations, at least some of the hub portions of the support lattice may be laterally interlocked with corresponding ones of the raised features of the FF plate to prevent the support lattice from moving in a direction parallel to the floor surface of the FF plate.

In some implementations, at least some of the hub portions of the support lattice may define a hole. At least some of the raised features may include a pin extending from the floor surface of the FF plate and into the corresponding hole.

In some implementations, at least some of the pins may terminate at a tapered tip that extends into the corresponding hole of the hub portions.

In some implementations, at least some of the pins may have an end surface that faces the support lattice and a projection that extends from the end surface and into the corresponding hole.

In some implementations, the corresponding hole may be a through-hole, a recess, a cavity, or an opening.

In some implementations, the support lattice may have a polygonal shape with a plurality of corners and a plurality of edges extending between the corners. The hub portions may include a first set of hub portions that are positioned adjacent to the edges or the corners and include the corresponding holes.

In some implementations, the hub portions may further include a second set of hub portions that are spaced inward from the edges and the corners and do not include the corresponding holes.

In some implementations, the hub portions may further include a second set of hub portions that are spaced inward from the edges and the corners and include the corresponding holes.

In some implementations, at least some of the raised features may terminate at an end defining a hole that is a through-hole, a recess, a cavity, or an opening. At least some of the hub portions of the support lattice may include a projection extending into the corresponding hole of the raised features.

In some implementations, at least some of the hub portions may be each diffusion bonded, welded, or otherwise fused or bonded to a corresponding one of the raised features.

In some implementations, at least some of the hub portions may be each diffusion bonded, welded, or otherwise fused or bonded to a corresponding one of the raised features that are positioned adjacent to an outside edge of the FF plate.

In some implementations, at least some of the hub portions are each diffusion bonded, welded, or otherwise fused or bonded to a corresponding one of the raised features.

In some implementations, each one of the hub portions may be diffusion bonded, welded, or otherwise fused or bonded to a corresponding one of the raised features, with such couplings between those hub portions and those raised features being positioned throughout the FF plate.

In some implementations, at least some of the raised features may include a mesa feature.

In some implementations, the support lattice may include the hub portions distributed in a repeating pattern, a two-dimensional array, a triangular lattice pattern, or a square lattice pattern.

In some implementations, at least some of the hub portions may be a joint connected to at least four other hub portions by a corresponding one of at least four beam portions.

In some implementations, each of the beam portions may have a common length, and the beam portions may be angularly spaced apart from one another by a common angle.

In some implementations, each of the joints may be connected to eight other hub portions by a corresponding one of eight beam portions.

In some implementations, four of the eight beam portions may have a first common length, and the other four of the eight beam portions may have a second common length that is longer than the first common length.

In some implementations, the beam portions may be angularly spaced apart from one another by a common angle.

In some implementations, the support lattice may be configured to decrease the intrusion of the PTL into the one or more flow fields when the PTL is compressed towards the FF plate with a pressure up to 400 psi.

In some implementations, the raised features of the FF plate may be a plurality of hydroformed features or a plurality of stamped features.

In some implementations, the FF plate may be made of titanium. The FF plate may have a predetermined thickness up to 200 μm. The flow field depth may be at least 320 μm.

In some implementations, at least some of the hub portions may have a first thickness along a longitudinal direction orthogonal to the FF plate. At least some of the beam portions may have a second thickness along the longitudinal direction. The first thickness of the hub portions may be greater than the second thickness of the beam portions.

In some implementations, the support lattice may be made of a corrosion-resistant conductive pure valve metal or a transition metal. The corrosion-resistant conductive pure valve metal may be titanium, titanium alloy, niobium, tantalum, zirconium, and/or tungsten. The transition metal may have an inert conductive coating and be made of stainless steel, nickel copper, and/or a carbon-based material.

A flow field plate assembly may be provided for an electrochemical cell of an electrochemical cell system. The flow field plate assembly may include a flow field plate (FF plate) having a floor surface and a plurality of raised features protruding from the floor surface. The flow field plate assembly may further include a grating having a plurality of bar portions and a plurality of crossmember portions interconnecting the bar portions. At least some of the bar portions may be supported by the raised features of the FF plate. The raised features of the FF plate may be distributed across the floor surface. The bar portions of the grating and the raised features of the FF plate may space apart the crossmember portions from the floor surface so as to define a flow field depth.

In some implementations, the bar portions and the crossmember portions may be flush on a first side of the grating facing away from the floor surface of the FF plate. The bar portions may protrude beyond the crossmember portions on a second side of the grating that contacts the raised features of the FF plate, such that the bar portions act to elevate the crossmember portions away from the floor surface of the FF plate.

In some implementations, the flow field plate assembly may further include a porous transport layer (PTL). The bar portions and the crossmember portions of the grating may be configured to distribute a load across the PTL and decrease an intrusion of the PTL into the one or more flow fields when the PTL is compressed towards the FF plate.

In some implementations, the bar portions and the crossmember portions of the grating may be configured to decrease the intrusion of the PTL into the one or more flow fields when the PTL is compressed towards the FF plate.

In some implementations, the bar portions may be positioned non-parallel relative to the crossmember portions.

In some implementations, a first thickness of the bar portions may be at least two times greater than a second thickness of the crossmember portions.

In some implementations, the grating may be a single-piece component including the bar portions and the crossmember portions.

In some implementations, at least some of the bar portions or crossmember portions may be each diffusion bonded, welded, or otherwise fused or bonded to a corresponding one of the raised features.

In some implementations, at least some of the raised features may define a plurality of parallel channels. At least some of the bar portions may be diffusion bonded, welded, or otherwise fused or bonded to the raised features.

In some implementations, at least some of the bar portions may be diffusion bonded, welded, or otherwise fused or bonded to the raised features positioned at an edge of the FF plate.

In some implementations, at least some of the bar portions may be diffusion bonded, welded, or otherwise fused or bonded to the raised features.

In some implementations, each one of the bar portions may be diffusion bonded, welded, or otherwise fused or bonded to a corresponding one of the raised features of the FF plate throughout the FF plate.

In some implementations, the grating may be configured to decrease the intrusion of the PTL into the one or more flow fields when the PTL is compressed towards the FF plate with a pressure up to 400 psi.

In some implementations, the raised features of the FF plate may be a plurality of hydroformed features or a plurality of stamped features.

In some implementations, the FF plate may be made of titanium. The FF plate may have a predetermined thickness up to 200 μm. The flow field depth may be at least 320 μm.

In some implementations, at least some of the hub portions may have a first thickness along a longitudinal direction orthogonal to the FF plate. At least some of the beam portions may have a second thickness along the longitudinal direction. The first thickness of the hub portions may be greater than the second thickness of the beam portions.

In some implementations, the support lattice may be made of a corrosion-resistant conductive pure valve metal or a transition metal. The corrosion-resistant conductive pure valve metal may be titanium, titanium alloy, niobium, tantalum, zirconium, or tungsten. The transition metal may have an inert conductive coating and may be made of stainless steel, nickel copper, or a carbon-based material.

### BRIEF DESCRIPTION OF THE FIGURES

FIG. 1 depicts an enlarged perspective view of an example electrochemical cell system having an electrochemical cell configured to decrease or prevent intrusion of a porous transport layer into a flow field.

FIG. 2 depicts an enlarged upper perspective view of a representative periodic portion or unit of the electrochemical cell system of FIG. 1 as taken from Region 2 and characterizes its structure with the system having a cathode shim, a cathode flow field plate, a gas diffusion layer, a catalyst coated membrane, a porous transport layer, an anode flow field plate assembly (assembly), and an anode shim.

FIG. 3 depicts an enlarged upper perspective view of the assembly and the anode shim of FIG. 1, illustrating the assembly having a support lattice and an anode flow field plate (anode FF plate).

FIG. 4 depicts an upper perspective view of the anode FF plate and the anode shim of FIG. 3, illustrating the anode FF plate having a plurality of dimples.

FIG. 5 depicts an enlarged lower perspective view of a portion of the support lattice of FIG. 3, illustrating the support lattice having a plurality of hub portions and a plurality of beam portions interconnecting the hub portions.

FIG. 6 depicts an enlarged upper perspective view of yet another example of the assembly and the anode shim of FIG. 1.

FIG. 7 depicts an upper perspective view of the anode FF plate and the anode shim of FIG. 6, illustrating the anode FF plate having a plurality of polyhedral pins.

FIG. 8 depicts a lower perspective view of the support lattice of FIG. 6, illustrating the support lattice having a plurality of hub portions and a plurality of beam portions interconnecting the hub portions, with the hub portions being thicker than the beam portions.

FIG. 9 depicts an enlarged upper perspective view of still another example of the assembly and the anode shim of FIG. 1.

FIG. 10 depicts an upper perspective view of the anode FF plate and the anode shim of FIG. 9, illustrating the anode FF plate having a plurality of tapered pins.

FIG. 11 depicts a lower perspective view of the support lattice of FIG. 9, illustrating the hub portions being thicker than the beam portions.

FIG. 12 depicts an enlarged upper perspective view of another example of the assembly and the anode shim of FIG. 1.

FIG. 13 depicts an upper perspective view of the anode FF plate and the anode shim of FIG. 12, illustrating the anode FF plate having a plurality of tapered pins positioned at a corner of the anode FF plate and a plurality of polyhedral pins spaced inward from the corner.

FIG. 14 depicts a lower perspective view of the support lattice of FIG. 12, illustrating the hub portions being thicker than the beam portions.

FIG. 15 depicts an enlarged upper perspective view of yet another example of the assembly and the anode shim of FIG. 1.

FIG. 16 depicts an upper perspective view of the anode FF plate and the anode shim of FIG. 15, illustrating the anode FF plate having a plurality of polyhedral pins with a reduced thickness.

FIG. 17 depicts a lower perspective view of the support lattice of FIG. 15, illustrating the support lattice having a plurality of hub portions with recesses.

FIG. 18 depicts an enlarged upper perspective view of still another example of the assembly and the anode shim of FIG. 1.

FIG. 19 depicts an upper perspective view of the anode FF plate and the anode shim of FIG. 18, illustrating the anode FF plate having a plurality of polyhedral pins positioned at a corner of the anode FF plate and having a thickness that is less than that of polyhedral pins spaced inward from the corner.

FIG. 20 depicts a lower perspective view of the support lattice of FIG. 18, illustrating the support lattice having a plurality of hub portions including recesses and positioned at a corner of the support lattice.

FIG. 21 depicts an enlarged upper perspective view of another example of the assembly and the anode shim of FIG. 1.

FIG. 22 depicts an upper perspective view of the assembly and the anode shim of FIG. 21, illustrating the anode FF plate having a plurality of polyhedral pins including recesses and distributed across the anode FF plate.

FIG. 23 depicts a lower perspective view of the support lattice of FIG. 21, illustrating the support lattice having a plurality of hub portions each including a projection.

FIG. 24 depicts an enlarged upper perspective view of yet another example of the assembly and the anode shim of FIG. 1.

FIG. 25 depicts an upper perspective view of the anode FF plate and the anode shim of FIG. 24, illustrating the anode FF plate having a plurality of polyhedral pins including recesses and positioned at a corner of the anode FF plate.

FIG. 26 depicts a lower perspective view of the support lattice of FIG. 24, illustrating a plurality of hub portions including projections and positioned at a corner of the support lattice.

FIG. 27 depicts an enlarged upper perspective view of still another example of the assembly and the anode shim of FIG. 1.

FIG. 28 depicts an upper perspective view of the anode FF plate and the anode shim of FIG. 27, illustrating the anode FF plate having a plurality of polyhedral pins distributed across the anode FF plate, with each pin including a projection.

FIG. 29 depicts a lower perspective view of the support lattice of FIG. 27, illustrating a plurality of hub portions distributed across the support lattice, with each hub portion including a through-hole.

FIG. 30 depicts an enlarged upper perspective view of another example of the assembly and the anode shim of FIG. 1.

FIG. 31 depicts an upper perspective view of the anode FF plate and the anode shim of FIG. 30, illustrating the anode FF plate having a plurality of polyhedral pins including projections and positioned at a corner of the anode FF plate.

FIG. 32 depicts a lower perspective view of the support lattice of FIG. 30, illustrating a plurality of hub portions including through-holes and positioned at a corner of the support lattice.

FIG. 33 depicts an enlarged upper perspective view of another example of the assembly and the anode shim of FIG. 1, with the assembly having an anode FF plate and a grating.

FIG. 34 depicts an upper perspective view of the anode FF plate and the anode shim of FIG. 33, illustrating the anode field plate having a plurality of straight parallel channels.

FIG. 35 depicts an enlarged lower perspective view of a portion of the grating of FIG. 33, illustrating the grating having a plurality of bar portions and a plurality of crossmember portions interconnecting the bar portions.

### DETAILED DESCRIPTION

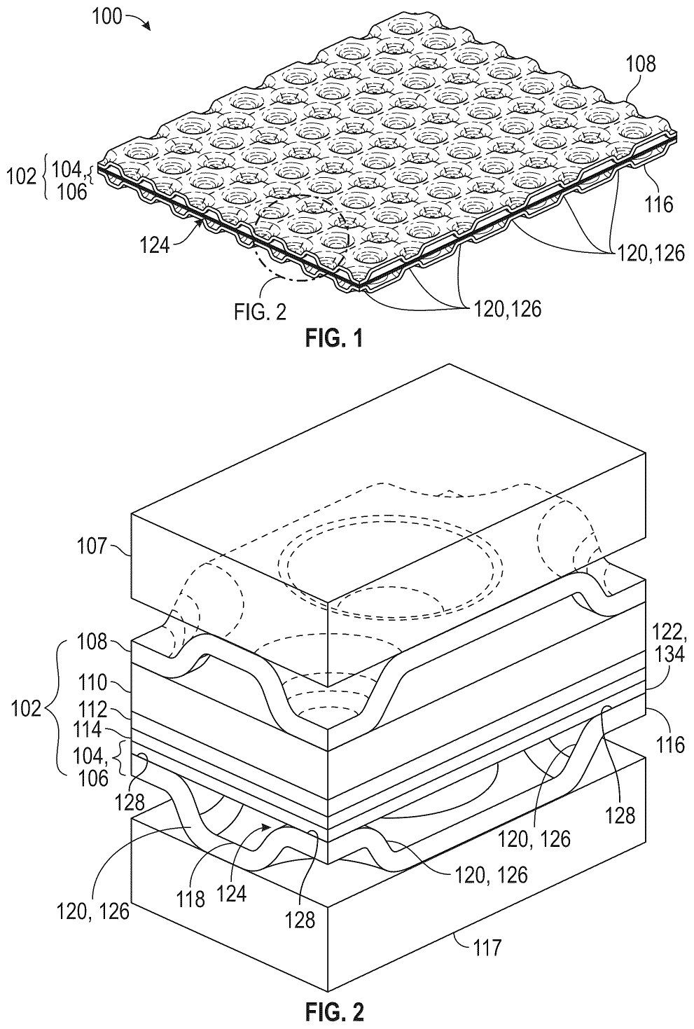

Referring to FIGS. 1 and 2, an electrochemical cell system 100 includes an electrochemical cell 102 (e.g., fuel cells, electrolyzer cells, etc.) with a flow field plate assembly 104 (e.g., an anode flow field plate assembly 106, etc.). As shown in FIG. 2, the electrochemical cell 102 includes multiple elements with corresponding functionalities, including at least a cathode shim 107, a cathode flow field plate 108 (cathode FF plate), a gas diffusion layer 110 (GDL), a catalyst coated membrane 112 (CCM), a porous transport layer 114 (PTL), the anode flow field plate assembly 106 (assembly), and an anode shim 117. As described in detail below, the assembly 104 includes an anode flow field plate 116 (anode FF plate) having a floor surface 118 and a plurality of raised features 120 distributed across the floor surface 118. The anode FF plate 116 further includes a reinforcement layer 122, with one or more flow fields 124 defined by the floor surface 118, the raised features 120, and the reinforcement layer 122. The reinforcement layer 122 is configured to decrease or prevent an intrusion of the PTL 114 into the flow fields 124 when the PTL 114 is compressed towards the anode FF plate 116 (e.g., with a pressure up to 400 psi). Other examples of the reinforcement layer may be configured to decrease or prevent the potential for PTL intrusion when the PTL is compressed towards the anode FF plate under any pressure above or below 400 psi. As described in detail below, the reinforcement layer 122 may also, in some cases, serve to enable an increase in the depth of flow paths through the flow field and/or enable an increase in the spacing between the raised features 120 while reducing or minimizing PTL intrusion into the flow paths of the flow field, thereby reducing the hydraulic resistance through the flow field and decreasing stress in the PTL 114.

An anode conductor plate (not shown) may be in electrically conductive contact with the anode FF plate 116; similarly, a cathode conductor plate (not shown) may be in electrically conductive contact with the cathode FF plate 108. The anode FF plate 116 and the cathode FF plate 108 may be made from any of a variety of materials that are electrically conductive and otherwise capable of withstanding long-term exposure to the fluids flowed within the anode FF plate 116 and the cathode FF plate 108 during normal operating conditions. In some implementations, any FF plate of the system 100 (e.g., the anode FF plate 116, the cathode FF plate 108, etc.) may be made of a corrosion-resistant conductive pure valve metal (e.g., titanium, titanium alloy, niobium, tantalum, zirconium, tungsten, etc.). In other implementations, the FF plate (e.g., the anode FF plate 116, the cathode FF plate 108, etc.) may be made of a transition metal (e.g., stainless steel, nickel copper, a carbon-based material, etc.) and have an inert conductive coating.

The anode FF plate 116 and the cathode FF plate 108 may have inlets that correspond in location to the fluidic inlet ports of an anode end plate (not shown) and a cathode end plate (not shown), respectively. The anode FF plate 116 and the cathode FF plate 108 may further have outlets that correspond in location to the fluidic outlet ports of the anode end plate and the cathode end plate, respectively. As described in detail below, the anode FF plate 116 and the cathode FF plate 108 may each have one or more flow fields that are formed in faces of the anode FF plate 116 and the cathode FF plate 108, respectively, that are routed so as to allow the fluid that is conducted through the flow fields to come into contact with the adjacent GDL 110, the CCM 112, or the PTL 114 in a generally distributed manner.

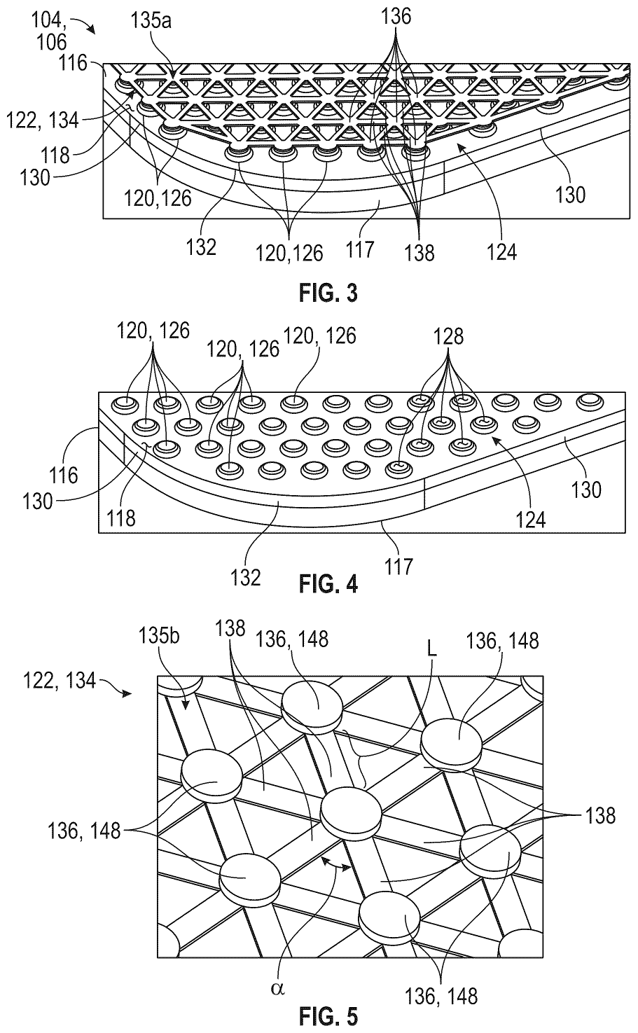

Referring to FIGS. 3 and 4, an example of the assembly 104 includes the anode FF plate 116 with the raised features 120 (e.g., a plurality of dimples 126) distributed across the floor surface 118 of the anode FF plate 116. In this example, the anode FF plate 116 is a plate made of titanium, which has a predetermined thickness and is hydroformed or stamped to produce the dimples 126 that protrude from the floor surface 118. In other examples, the anode FF plate may be a plate having any shape and made of any suitable material with any suitable raised features (e.g., pins with polygonal cross-sections, pins with round cross-sections, straight or serpentine channel walls with a uniform thickness, etc.) that are provided by other methods of manufacture (e.g., stamping, milling, machining, casting, etc.). As best shown in FIG. 4, each dimple 126 may have a mesa feature 128 (e.g., plateau or flat top surface). The mesa feature 128 may have a circular shape with a predetermined radius, and the dimples 126 may be spaced apart from one another by a predetermined distance to facilitate the assembly 106 with defining one or more flow fields that have a corresponding hydraulic resistance. As described in detail below, the reinforcement layer 122 further facilitates the raised features 120 and the floor surface 118 with defining the flow fields 124 and also distributing a load across the PTL 114 so as to decrease or prevent an intrusion of the PTL 114 into the flow fields 124. The anode FF plate 116 has a polygonal shape with a plurality of outer edges 130 extending between corresponding corners 132 of the anode FF plate 116. In this implementation, the anode FF plate 116 is supported by a shim 117. In examples where the shim 117 is employed, the shim 117 may serve to take up a difference in thicknesses between the various components. By taking up such differences in thickness between the various components, the shim 117 may enable proper sealing, prevent overcompression of soft or pliable components, and/or prevent intrusion of the PTL 114 into the flow fields 124 that can result from overcompression of the soft or pliable components. The thickness of the shim 117 is dependent on the particular arrangement of the electrochemical cell 102. If the shim 117 is too thick, the shim 117 may prevent proper sealing, lead to overcompression of the soft or pliable components, and/or lead to increasing a degree to which the PTL 114 intrudes into the flow fields 124. If the shim 117 is too thin, then an undesirable gap may be introduced between the GDL 110 and the cathode FF plate 108. Such a gap between the GDL 110 and the cathode FF plate 108 can lead to flow distribution problems on the affected side of the electrochemical cell 102. It may be preferable to have the thickness of the shim 117 be zero. That is, in examples where the electrochemical cell 102 has components whose thickness match, the shim 117 may be omitted. However, in examples where the electrochemical cell 102 may benefit from the use of the shim 117, the shim 117 may have a thickness in the range of about 0.10 mm to about 10 mm. For example, and without limitation, the shim 117 may have a thickness of about 0.10 mm, about 0.20 mm, about 0.30 mm, about 0.40 mm, about 0.50 mm, about 1.0 mm, about 2.0 mm, about 3.0 mm, about 4.0 mm, about 5.0 mm, or about 10.0 mm. In still other implementations, the shim 117 may have a thickness that is less than 0.10 mm or greater than 10.0 mm.

Referring to FIG. 5, in this example, the reinforcement layer 122 is a support lattice 134 having a plurality of hub portions 136 and a plurality of beam portions 138 interconnecting the hub portions 136. The combined height of the hub portions 136 and the raised features 120 may act to elevate the beam portions 138 away from the floor surface 118 so as to define a flow field depth. Put another way, the hub portions 136 of the support lattice 134 may facilitate the raised features 120 of the anode FF plate 116 with defining the flow field depth when, for example, the raised features 120 have a maximum height corresponding with the maximum draw of depth for the hydroformed or stamped anode FF plate 116. The hub portions 136 and the beam portions 138 may be flush or coplanar on a first side 135a (FIG. 3) of the support lattice 134 facing away from the floor surface 118 of the anode FF plate 116. The hub portions 136 may protrude beyond the beam portions 138 on a second side 135b (FIG. 5) of the support lattice 134 that contacts the raised features 120 of the anode FF plate 116, such that the hub portions 136 act to elevate the beam portions 138 away from the floor surface 118 of the anode FF plate 116. In one example, at least some of the hub portions 136 may have a first thickness (e.g., 200 μm) along a longitudinal direction orthogonal to the anode FF plate 116, and at least some of the beam portions 138 may have a second thickness (e.g., 100 μm) along the longitudinal direction, with the first thickness of the hub portions 136 being greater than the second thickness of the beam portions 138. In other examples, at least some hub portions may have a thickness above or below 200 μm, and at least some of the beam portions 138 may have a thickness above or below 100 μm. Any suitable portion of the reinforcement layer may elevate other portions of the reinforcement layer away from the anode FF plate so as to define the flow field depth.

The hub portions 136 and the beam portions 138 of the support lattice 134 are configured to distribute a load across the PTL 114 and decrease or prevent intrusion of the PTL 114 into the flow fields 124 when the PTL 114 is compressed towards the anode FF plate 116 (e.g., with a pressure up to 400 psi). At least some of the hub portions 136 are supported by the raised features 120 of the anode FF plate 116 (FIGS. 3 and 4). In this example, none of the beam portions 138 may be directly engaged and supported by any of the raised features 120 of the anode FF plate 116. In other examples, at least some of the beam portions may be directly engaged and supported by corresponding raised features of the anode FF plate. In some implementations, the reinforcement layer 122 may be made of a corrosion-resistant, conductive pure valve metal (e.g., titanium, titanium alloy, niobium, tantalum, zirconium, tungsten, etc.). In still other implementations, the reinforcement layer 122 may be made of a transition metals (e.g., stainless steel, nickel, copper, carbon-based materials, etc.) and an inert conductive coating to protect against corrosion.

The reinforcement layer 122 is laterally interlocked with the anode FF plate 116 to prevent the reinforcement layer 122 from moving in a direction parallel to the anode FF plate 116. At least some of the hub portions 136 of the support lattice 134 may be laterally interlocked with corresponding raised features 120 of the anode FF plate 116. In one example, the hub portions 136 include a first set 140 of hub portions (FIG. 5) that are positioned at one or more edges or corners of the support lattice 134, and the hub portions 136 further include a second set 142 of hub portions that are spaced apart from the edges and the corners of the support lattice 134. At least some of the hub portions of the first and second sets 140, 142 (e.g., every hub portion 136 of both of the first and second sets 140, 142) may be diffusion bonded, welded, or otherwise fused or bonded to the raised features 120 (e.g., the mesa feature 128 of corresponding dimples 126) on the anode FF plate 116. In another example, none of the hub portions 136 of the first set 140 are diffusion bonded, welded, or otherwise fused or bonded to corresponding raised features 120 (e.g., the mesa feature 128 of corresponding dimples 126 positioned at the corners 132 and the edges 130 of the anode FF plate 116), and at least some of the hub portions 136 of the second set 142 are diffusion bonded, welded, or otherwise fused or bonded to corresponding raised features 120 (e.g., the mesa feature 128 of corresponding dimples 126 spaced inward from the corners 132 and the edges 130 of the anode FF plate 116). In yet another example, none of the hub portions 136 of the second set 142 are diffusion bonded, welded, or otherwise fused or bonded to corresponding raised features 120, and at least some of the hub portions 136 of the first set 140 are diffusion bonded, welded, or otherwise fused or bonded to corresponding raised features 120. Each hub portion 136 that directly engages and is supported by the corresponding raised feature 120 may facilitate the assembly with decreasing or preventing PTL intrusion into the flow paths of the flow field and elevating the beam portions 138 away from the floor surface 118 of the anode FF plate 116 to define the flow field depth, with or without those hub portions being diffusion bonded, welded, or otherwise fused or bonded to corresponding raised features.

As best shown in FIG. 5, at least some of the hub portions 136 (e.g., each hub portion 136 spaced inward from the corners of the support lattice) are joints 148, each connected to four or more other hub portions 136 by a corresponding number of beam portions 138. In the example depicted in FIG. 5, each joint 148 spaced inward from the outer edges and corners of the support lattice 134 is connected to six other surrounding hub portions 136 by a corresponding one of six beam portions 138. The beam portions 138 have a common length L, and the beam portions 138 are angularly spaced apart from one another by a common angle α. In other examples, the joint may be connected to more or fewer than four other hub portions by more or fewer than four beam portions. The beam portions may have different lengths and be angularly spaced apart from one another by multiple non-uniform angles. As described in detail below, the support lattice may include the hub portions distributed in a repeating pattern, a two-dimensional array, a triangular lattice pattern, a square lattice pattern, or any suitable lattice pattern. While each hub portion 136, 140 in this example has a circular profile, at least some of the hub portions in other examples may have a non-circular profile, e.g., a hexagonal profile.

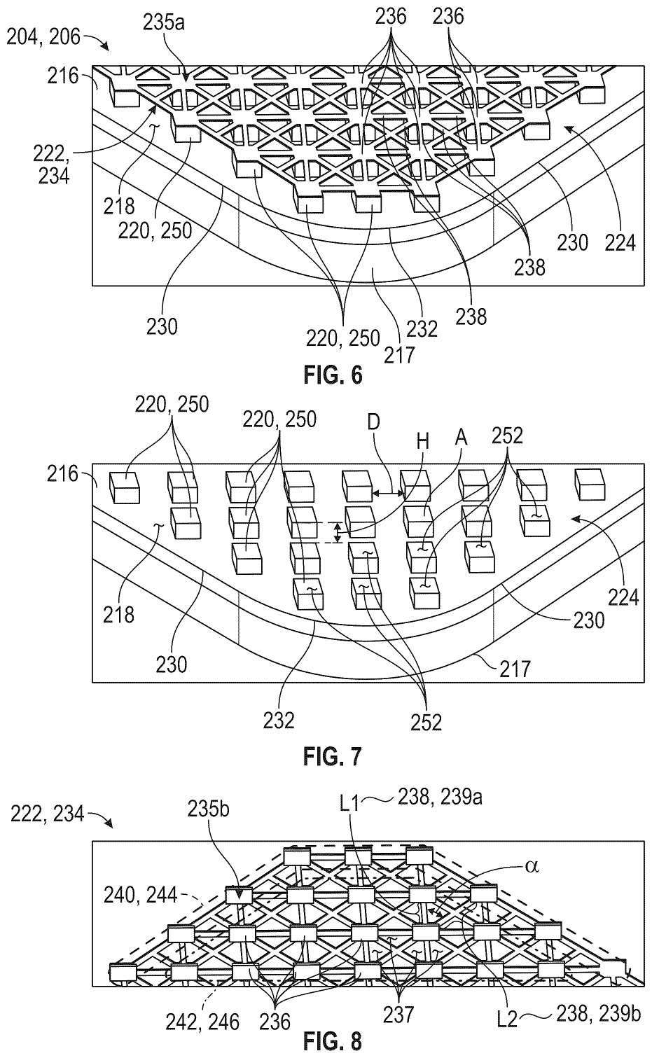

Referring to FIGS. 6-8, another example of an anode FF plate assembly 206 (assembly) is somewhat similar to the assembly 106 of FIGS. 3-5. To avoid undue repetition, elements in the implementation of FIGS. 6-8 that are analogous to elements shown in FIGS. 3-5 are called out with numbers that share the same last two digits as those analogous elements in FIGS. 3-5. Thus, the discussion provided above with respect to the elements of the implementation of FIGS. 3-5 will be understood to be equally applicable to the analogous elements in FIGS. 6-8 unless indicated otherwise. In the interest of conciseness, discussion of these elements that would be redundant of earlier discussion herein of similar elements is not provided, with the understanding that the earlier discussion of such elements is applicable to these similar elements in FIGS. 6-8.

While the raised features 120 of FIGS. 3-5 are dimples 126, the raised features 220 depicted in FIGS. 6-8 are pins 250 (e.g., pins with polygonal cross-sections, pins with round cross-sections, etc.). In other examples, as described in detail below, the raised features may be straight or serpentine channel walls with a uniform thickness. Each pin 250 (FIG. 7) has a predetermined height H and a mesa feature 252 with a predetermined surface area A. The pins 250 are spaced apart from one another by a predetermined distance D and may, for example, be arranged in a square, diamond, triangular, or other lattice pattern. While the support lattice 134 of FIG. 5 includes hub portions 136 each having a circular cross-section, the support lattice 234 includes a plurality of hub portions 236 (FIG. 8), and at least some of these hub portions 236 (e.g., every hub portion) have a polygonal cross-section. Furthermore, while at least the interior hub portions 136 of FIG. 5 spaced inward from the outer edges and corners of the support lattice 124 are interconnected with six other hub portions 136 by six corresponding beam portions 138, each hub portion 236 (e.g., each of the interior hub portions spaced inward from the outer edges and corners of the support lattice) is interconnected with eight other hub portions 236 by eight corresponding beam portions 238. The beam portions 238 are angularly spaced apart from one another by a common angle α. As best shown in FIG. 8, the eight beam portions 238 may include four beam portions 239a having a first common length L1 and four beam portions 239b having a second common length L2, with the second common length L2 being greater than the first common length L1. In one example, the ratio between the first common length L1 and the second common length L2 may be a ratio of one to the square root of two (1:\sqrt{2}). Each first beam portion 238 may be connected (e.g., at its midpoint) to a corresponding second beam portion 239b (e.g., at its midpoint). The reinforcement layer 222 may include a support lattice having any suitable pattern.

The hub portions 236 act to elevate the beam portions 238 away from the floor surface 218 of the anode FF plate 216 to define the flow field depth. The hub portions 236 and the beam portions 238 may be flush or coplanar on a first side 235a (FIG. 6) of the support lattice 234 facing away from the anode FF plate 216. The hub portions 236 may protrude beyond the beam portions 238 on a second side 235b (FIG. 8) of the support lattice 234 that contacts the raised features 220 of the anode FF plate 216. In this example, each hub portion 236 may have a first thickness in the longitudinal direction orthogonal to the anode FF plate 216. The beam portions 239a, 239b, in this example, may each have second and third thicknesses, respectively, that are less than the first thickness so as to facilitate the pins 250 with defining a flow field depth and corresponding hydraulic resistance. Any portion of the reinforcement layer 222 (e.g., the hub portions 236, etc.) may elevate other portions (e.g., the beam portions 238, etc.) of the reinforcement layer 222 away from the floor surface 218 of the anode FF plate 216 to define the flow field depth 224. Furthermore, the reinforcement layer 222 may include voids 237 (FIG. 8) defined between the hub portions 236 and the beam portions 238. Each void 237 may be smaller than a surface area of each mesa feature 252, thereby preventing the pins 250 from being inserted through the voids 237 and preventing the floor surface 218 and the reinforcement layer 222 from contacting one another.

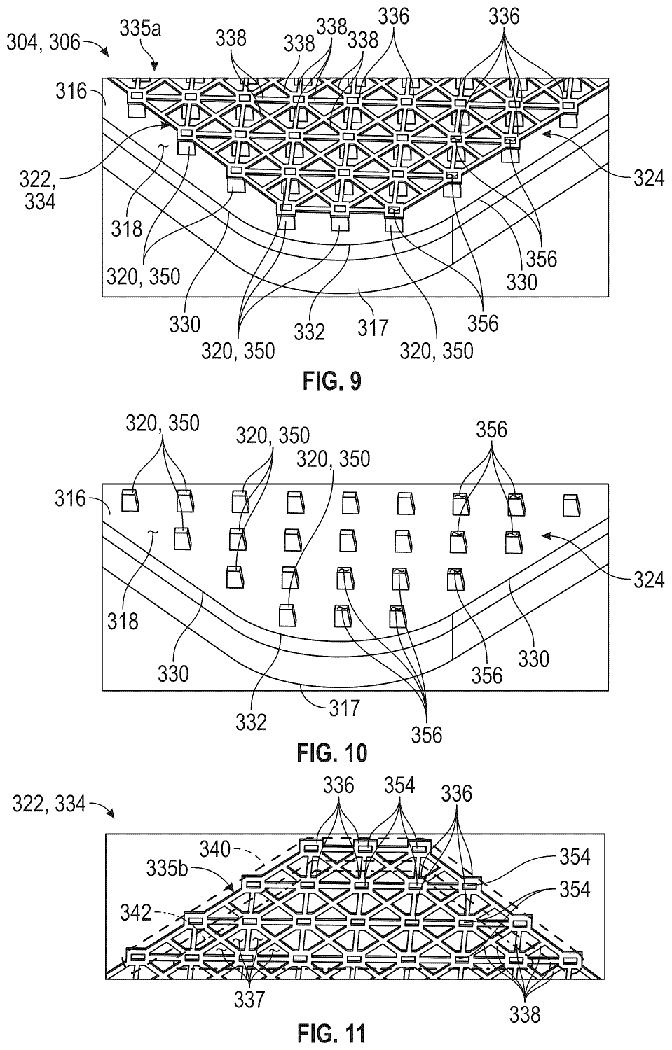

Referring to FIGS. 9-11, yet another example of an anode FF plate assembly 306 (assembly) is similar to the assembly 206 of FIGS. 6-8. As with previous Figures, to avoid undue repetition, elements in the implementation of FIGS. 9-11 that are analogous to elements shown in FIGS. 6-8 are called out with numbers that share the same last two digits as those analogous elements in FIGS. 6-8. Thus, the discussion provided above with respect to the elements of FIGS. 6-8 will be understood to be equally to the analogous elements in FIGS. 9-11 unless indicated otherwise. In the interest of conciseness, discussion of these elements that would be redundant of earlier discussion herein of similar elements is not provided, with the understanding that the earlier discussion of such elements is applicable to these similar elements in FIGS. 9-11.

While the support lattice 234 of FIG. 8 includes hub portions 236 without holes, the support lattice 334 of FIG. 11 includes hub portions 336 that each define a hole (e.g., a through-hole 354, a recess, an opening, a cavity, etc.). Furthermore, while each raised feature 220 of FIG. 7 is a pin 250 with a constant width along its height, at least some of the raised features 320 of FIG. 10 (e.g., each one of the raised features 320) terminate at a tapered tip 356 that extends into the corresponding through-hole 354 of the hub portions 336 to laterally interlock the reinforcement layer 322 with the anode FF plate 316. At least some of the tapered tips 356 may be flush or coplanar with the first side 335a (FIG. 9) of the support lattice 334 facing away from the floor surface 318 of the anode FF plate 316, such that the tapered tips 356 of the anode FF plate 316 and the support lattice 334 may distribute a load across the PTL. The pins 350 may be taller than the pins 250 of FIG. 7, such that both assemblies 206, 306 may provide a common hydraulic resistance. In other implementations, the flow fields 224, 324 may have different flow field depths. In still other implementations, at least some of the tapered tips may protrude into the through-holes 354 and beyond the first side 335a of support lattice 334, or at least some of the tapered tips may be disposed entirely within corresponding through-holes 354. Furthermore, while the hub portions 236 of FIGS. 6 and 8 are flush or coplanar with the beam portions 238 on the first side 235b (FIG. 6) of the support lattice 234 and protrude beyond the beam portions 238 on the second side 235b (FIG. 8) of the support lattice 234, the hub portions 336 of FIGS. 9 and 11 are flush or coplanar with the beam portions 338 on both the first side 335a (FIG. 9) and the second side 335b (FIG. 11) of the support lattice 334. It is contemplated that the hub portions 336 in other implementations may protrude beyond the beam portions 338 on the first side 335a and/or the second side 335b of the support lattice 334.

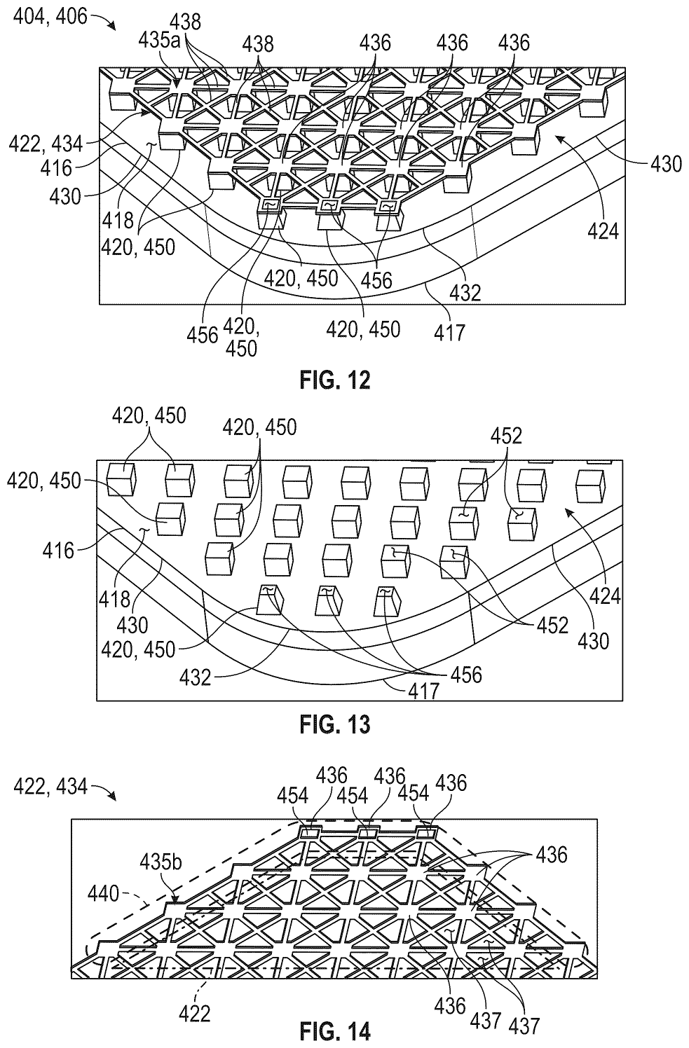

Referring to FIGS. 12-14, still another example of an anode FF plate assembly 406 (assembly) is similar to the assembly 306 of FIGS. 9-11. As with previous Figures, to avoid undue repetition, elements in the implementation of FIGS. 12-14 that are analogous to elements shown in FIGS. 9-11 are called out with numbers that share the same last two digits as those analogous elements in FIGS. 9-11. Thus, the discussion provided above with respect to the elements of FIGS. 9-11 will be understood to be equally to the analogous elements in FIGS. 12-14 unless indicated otherwise. In the interest of conciseness, discussion of these elements that would be redundant of earlier discussion herein of similar elements is not provided, with the understanding that the earlier discussion of such elements is applicable to these similar elements in FIGS. 12-14.

While each raised feature 320 of FIGS. 9 and 10 terminates at the tapered tip 356, only the raised features 420 of FIGS. 12 and 13 that are positioned at the corners 432 of the anode FF plate 416 terminate at tapered tips 456. The raised features 420 that are spaced inward from the corners 432 are non-tapered pins 450 (e.g., pins with polygonal cross-sections, pins with round cross-sections, etc.). The non-tapered pins 450 have a constant cross-sectional width from the bottom of the corresponding pin 450 towards the top of that pin 450. While each hub portion 336 of FIG. 11 includes the corresponding through-hole 354 defined therein, the hub portions 436 of the second set 442 (FIG. 14) that are spaced inward from the corners 432 of the support lattice 434 do not include holes defined therein. Only the hub portions 436 of the first set 440 that are positioned at the corners 432 include corresponding through-holes 454 defined therein. The tapered tips 456 positioned at the corners 432 may be inserted into corresponding through-holes 454 to laterally interlock the reinforcement layer 422 with the anode FF plate 416. In this example, each of the hub portions 436 and the beam portions 438 are flush or coplanar relative to one another on both the first side 435a (FIG. 12) and the second side 435b (FIG. 14) of the support lattice 434. It is contemplated that the hub portions 436 in other implementations may protrude beyond the beam portions 438 on the first side 435a and/or the second side 435b of the support lattice 434. In particular, in implementations where the hub portions 436 extend beyond the beam portions 438 on the second side 435b, the hub portions 436 may contact the anode FF plate 416 and act to elevate the beams portions 438 away from the floor surface 418 of the anode FF plate 416.

The pins 450 that are positioned at the corners 432 of the anode FF plate 416 may be taller than the non-tapered pins 450 spaced inward from the corners 432 of the anode FF plate 416, such that the taller pins 450 with tapered tips 456 may be inserted into the through-holes 454 of corresponding hub portions 436 of the support lattice 434. In other examples where the hub portions 436 protrude beyond the beam portions 438 on the second side 435b of the support lattice 434, each of the pins 450 of both of the first and second sets 440, 442 may have a common height, and the pins 450 with tapered tips 456 may be inserted into the through-holes 454 of corresponding hub portions 436. While none of the non-tapered pins 450 may be diffusion bonded, welded, or otherwise fused or bonded to corresponding hub portions 436, at least some of the non-tapered pins in other examples may be diffusion bonded, welded, or otherwise fused or bonded to corresponding hub portions 436.

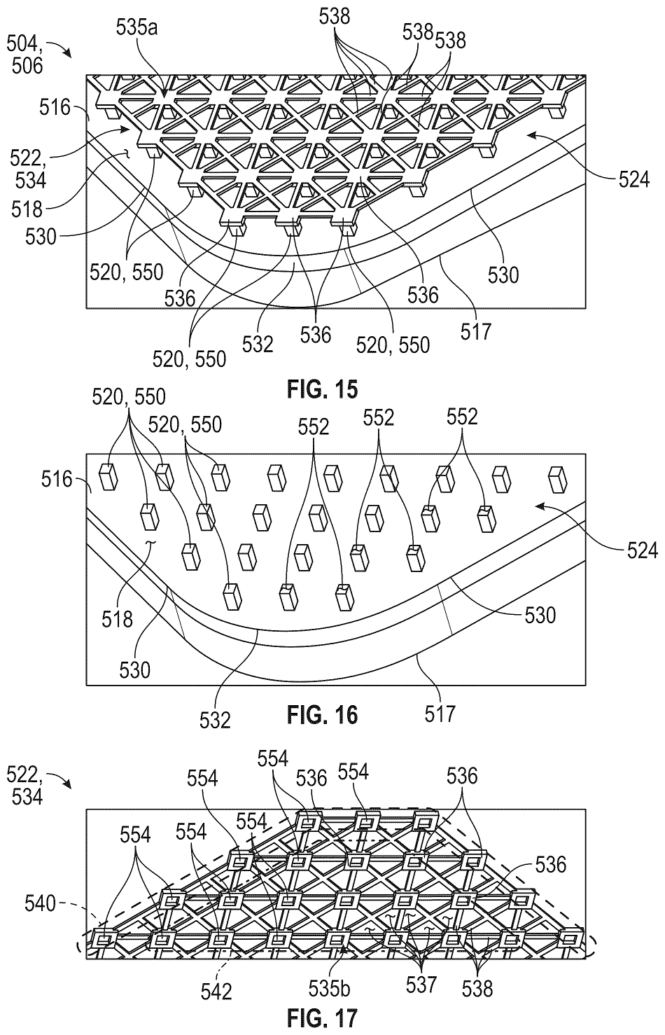

Referring to FIGS. 15-17, another example of an anode FF plate assembly 506 (assembly) is similar to the assembly 206 of FIGS. 6-8. As with previous Figures, to avoid undue repetition, elements in the implementation of FIGS. 15-17 that are analogous to elements shown in FIGS. 6-8 are called out with numbers that share the same last two digits as those analogous elements in FIGS. 6-8. Thus, the discussion provided above with respect to the elements of FIGS. 6-8 will be understood to be equally to the analogous elements in FIGS. 15-17 unless indicated otherwise. In the interest of conciseness, discussion of these elements that would be redundant of earlier discussion herein of similar elements is not provided, with the understanding that the earlier discussion of such elements is applicable to these similar elements in FIGS. 15-17.

While each polyhedral pin 250 of FIG. 7 has a first constant width from the bottom of the pin 250 to the top of the pin 250, each pin 550 of FIG. 16 has a second constant width from the bottom of the pin 550 to the top of the pin 550. The second constant width of each pin 550 may be less than the first constant width of each pin 250. A second hydraulic resistance corresponding with the second constant width may be lower than a first hydraulic resistance corresponding with the first constant width. While none of the hub portions 236 of FIG. 8 define holes, at least some of the hub portions 536 (e.g., every hub portion 536) may include a corresponding recess 554 defined therein. The raised features 520 may be pins 550 extending from the floor surface 518 and into the recess 554 of corresponding hub portion 536 so as to laterally interlock the reinforcement layer 522 with the anode FF plate 516. In this example, the pins 550 across the entire anode FF plate 516 (e.g., the pins at the corners of the anode FF plate, the pins at the edges of the anode FF plate, and the pins spaced inward from the corners and edges of the anode FF plate, etc.) may have a common height, and the recesses 554 across the entire support lattice 534 (e.g., the hub portions at the corners of the support lattice, the hub portions at the edges of the support lattice, and the hub portions spaced inward from the corners and edges of the support lattice, etc.) may have a common depth. In other implementations, at least some pins may have heights different from one another and at least some holes may have depths different from one another.

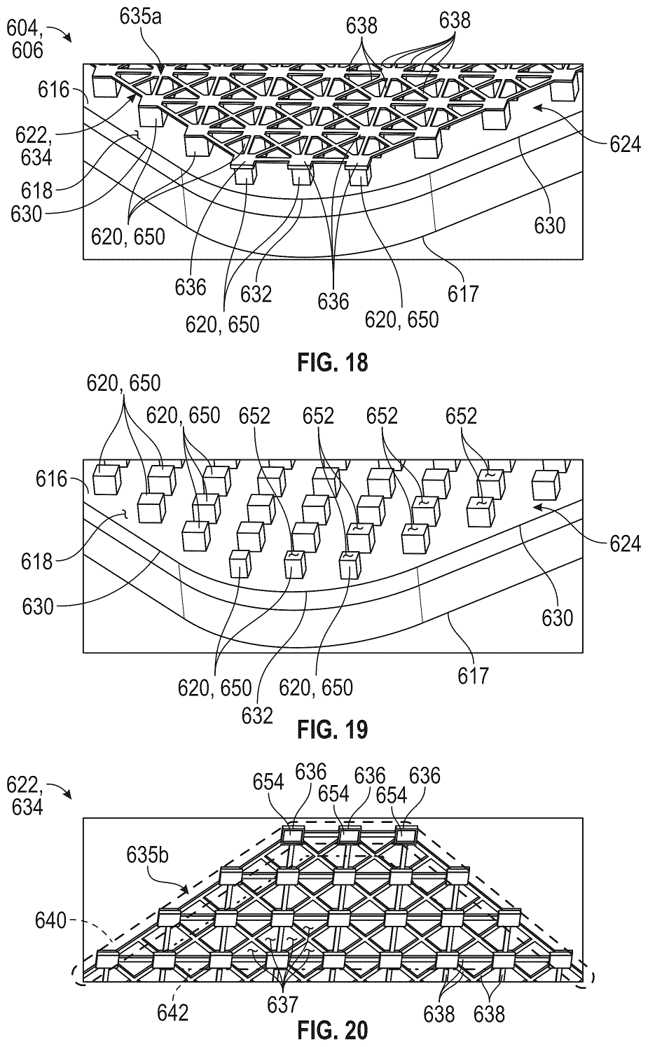

Referring to FIGS. 18-20, yet another example of an anode FF plate assembly 606 (assembly) is similar to the assembly 506 of FIGS. 15-17. As with previous Figures, to avoid undue repetition, elements in the implementation of FIGS. 18-20 that are analogous to elements shown in FIGS. 15-17 are called out with numbers that share the same last two digits as those analogous elements in FIGS. 15-17. Thus, the discussion provided above with respect to the elements of FIGS. 15-17 will be understood to be equally to the analogous elements in FIGS. 18-20 unless indicated otherwise. In the interest of conciseness, discussion of these elements that would be redundant of earlier discussion herein of similar elements is not provided, with the understanding that the earlier discussion of such elements is applicable to these similar elements in FIGS. 18-20.

While each hub portion 536 of FIG. 17 includes the recess 554 defined therein, the second set 642 of hub portions of FIG. 20 spaced apart from corners do not define recesses. Only the first set 640 of hub portions that are positioned at the corners of the support lattice 634 include corresponding recesses 654. In other implementations, the hub portions 636 at the edges between the corners of the support lattice 634 may have recesses defined therein. The raised features 620 (e.g., the polyhedral pins 650) are inserted into corresponding recesses 654 of the support lattice 634 so as to laterally interlock the reinforcement layer 622 with the anode FF plate 616. In some examples, where the hub portions 636 and the beam portions 638 are flush on the second side 635b of the support lattice 634 that contacts the anode FF plate 616, the pins 650 that are positioned at the corners 632 of the anode FF plate 616 and extend into corresponding recesses 654 may be taller than the pins 650 that are spaced inward from the corners 632 of the anode FF plate 616.

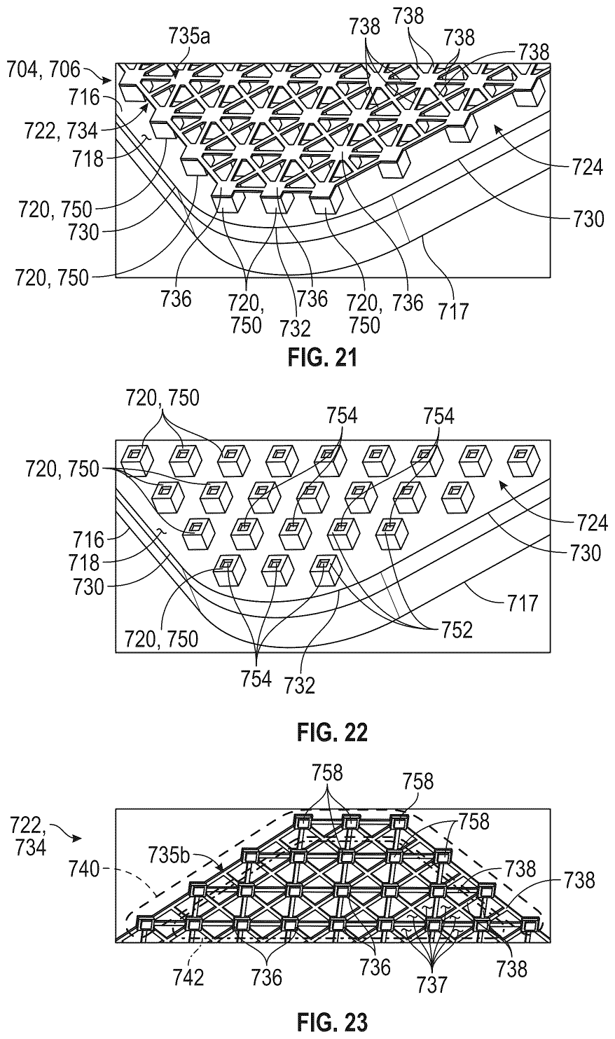

Referring to FIGS. 21-23, still another example of an anode FF plate assembly 706 (assembly) is similar to the assembly 206 of FIGS. 6-8. As with previous Figures, to avoid undue repetition, elements in the implementation of FIGS. 21-23 that are analogous to elements shown in FIGS. 6-8 are called out with numbers that share the same last two digits as those analogous elements in FIGS. 6-8. Thus, the discussion provided above with respect to the elements of FIGS. 6-8 will be understood to be equally to the analogous elements in FIGS. 21-23 unless indicated otherwise. In the interest of conciseness, discussion of these elements that would be redundant of earlier discussion herein of similar elements is not provided, with the understanding that the earlier discussion of such elements is applicable to these similar elements in FIGS. 21-23.

While each of the pins 250 of FIG. 7 has an end surface without a recess, at least some of the pins 750 of FIG. 22 (e.g., each one of the pins 750 distributed across the entire floor surface 718) have an end surface with a recess 754 defined therein. Furthermore, while each of the hub portions 236 of FIG. 8 has a surface without any projection facing the anode FF plate 216, at least some of the hub portions 736 of FIG. 23 (e.g., each of the hub portions 736) have a surface with a projection 758 inserted into the corresponding recess 754 of the pin 750 so as to laterally interlock the reinforcement layer 722 with the anode FF plate 716. The pins 750 across the entire floor surface 718 (FIG. 22) may have a common height. Each recess 754 may extend a predetermined depth below the end surface of the corresponding pin 750, and each projection 758 may have a height shorter than or equal to the depth of the corresponding recess 754. In such examples, the height of each projection 758 being less than the depth of the corresponding recess 754 may ensure that the support lattice is maintained as level across the anode FF plate 716.

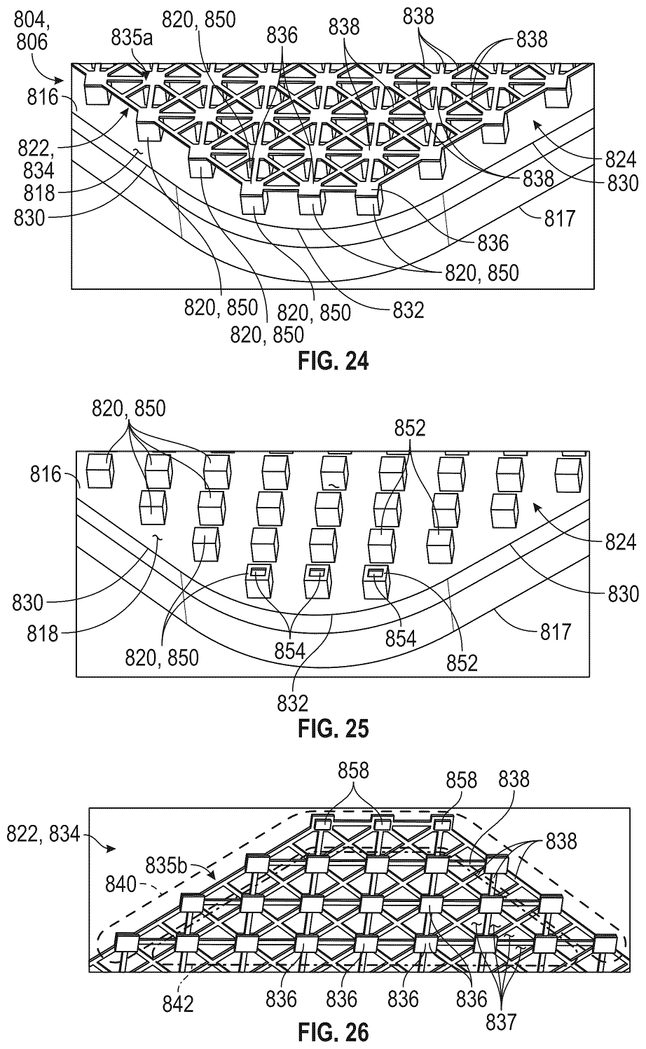

Referring to FIGS. 24-26, another example of an anode FF plate assembly 806 (assembly) is similar to the assembly 706 of FIGS. 21-23. As with previous Figures, to avoid undue repetition, elements in the implementation of FIGS. 24-26 that are analogous to elements shown in FIGS. 21-23 are called out with numbers that share the same last two digits as those analogous elements in FIGS. 21-23. Thus, the discussion provided above with respect to the elements of FIGS. 21-23 will be understood to be equally to the analogous elements in FIGS. 24-26 unless indicated otherwise. In the interest of conciseness, discussion of these elements that would be redundant of earlier discussion herein of similar elements is not provided, with the understanding that the earlier discussion of such elements is applicable to these similar elements in FIGS. 24-26.

While each pin 750 of FIG. 22 has an end surface with the recess 754 defined therein, the pins 850 of FIG. 25 that are spaced inward from the corners 832 do not include the recess. Only the pins 850 that are positioned at the corners 832 have corresponding recesses 854 defined therein. Furthermore, while each one of the hub portions 736 of FIG. 23 has a surface with a projection 758 inserted into the corresponding recess 754 of the pin 750, the hub portions 836 of FIG. 26 that are spaced inward from the corners of the support lattice do not include the projections. Only the hub portions 836 positioned at the corners of the support lattice 834 may have a projection 858 inserted into the corresponding recess 854 of the pins 850 so as to laterally interlock the reinforcement layer 822 with the anode FF plate 816. The pins 850 across the entire floor surface 818 (FIG. 25) may have a common height. Each recess 854 may extend a predetermined depth below the end surface of the corresponding pin 850, and each projection 858 may have a height shorter than the depth of corresponding recesses 854, such that the projections 858 may be inserted into corresponding recesses 854. In such examples, the height of each projection 858 being less than the depth of the corresponding recess 854 may ensure that the support lattice is maintained as level across the anode FF plate 816.

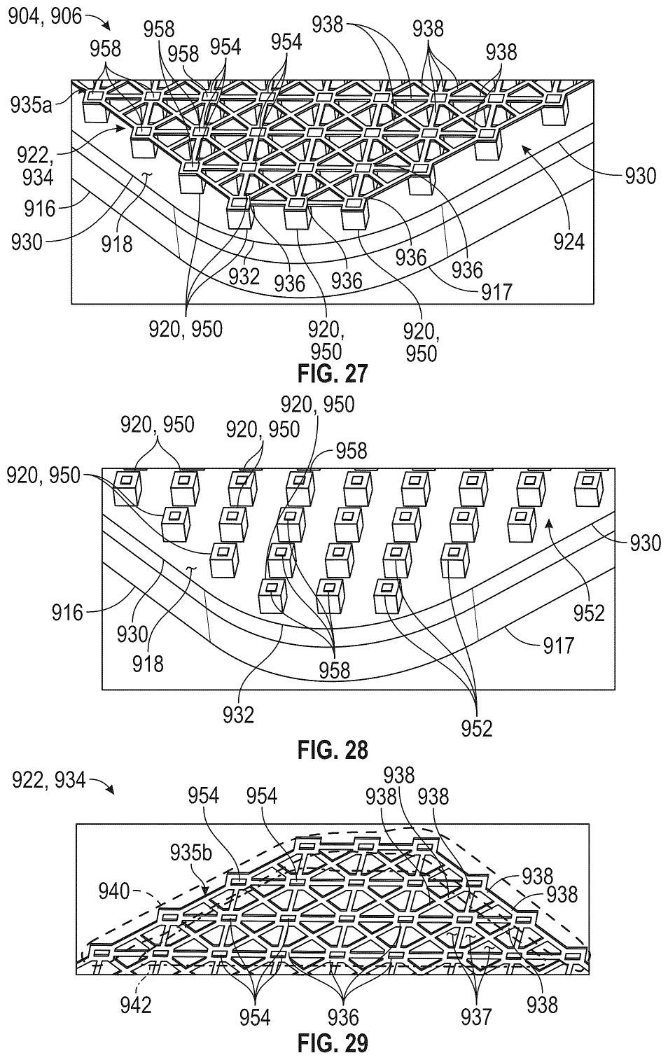

Referring to FIGS. 27-29, yet another example of an anode FF plate assembly 906 (assembly) is similar to the assembly 306 of FIGS. 9-11. As with previous Figures, to avoid undue repetition, elements in the implementation of FIGS. 27-29 that are analogous to elements shown in FIGS. 9-11 are called out with numbers that share the same last two digits as those analogous elements in FIGS. 9-11. Thus, the discussion provided above with respect to the elements of FIGS. 9-11 will be understood to be equally to the analogous elements in FIGS. 27-29 unless indicated otherwise. In the interest of conciseness, discussion of these elements that would be redundant of earlier discussion herein of similar elements is not provided, with the understanding that the earlier discussion of such elements is applicable to these similar elements in FIGS. 27-29.

While each of the raised features 320 of FIGS. 9 and 10 terminates at a tapered tip 356 that extends into the corresponding through-hole 354 of the hub portions 336, the raised features 920 of FIGS. 27 and 28 are pins 950 distributed across the floor surface 918, with at least some of the pins 950 (e.g., each one of the pins 950) having an end surface that faces the support lattice 934. Each pin 950 has a projection 958 that extends from the end surface and into the corresponding through-hole 954 to laterally interlock the reinforcement layer 922 with the anode FF plate 916. The pins 950 across the entire floor surface 918 (FIG. 28) may have a common height. Each projection 958 may extend an additional height above the corresponding pin 950 and be inserted into the corresponding through-hole 954 defined by the corresponding hub portion 936. The projection 958 has an end surface that is flush or coplanar with the first surface 935a of the support lattice 934, such that the projections 958 and the support lattice 934 may engage the PTL and distribute a load across the PTL.

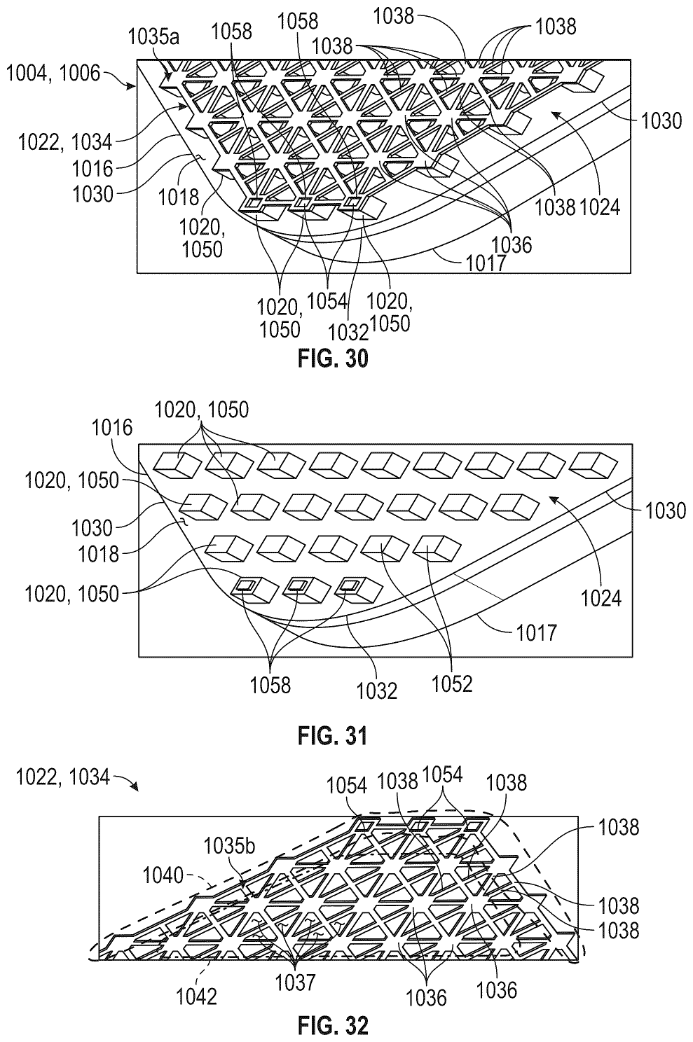

Referring to FIGS. 30-32, still another example of an anode FF plate assembly 1006 (assembly) is similar to the assembly 906 of FIGS. 27-29. As with previous Figures, to avoid undue repetition, elements in the implementation of FIGS. 30-32 that are analogous to elements shown in FIGS. 27-29 are called out with numbers that share the same last two digits as those analogous elements in FIGS. 27-29. Thus, the discussion provided above with respect to the elements of FIGS. 27-29 will be understood to be equally to the analogous elements in FIGS. 30-32 unless indicated otherwise. In the interest of conciseness, discussion of these elements that would be redundant of earlier discussion herein of similar elements is not provided, with the understanding that the earlier discussion of such elements is applicable to these similar elements in FIGS. 30-32.

While each one of the pins 950 of FIG. 28 has the projection 958 that extends from the end surface, the pins 1058 of FIG. 31 that are spaced inward from the corners 1032 do not include the projections. Only the pins 1058 positioned at the corners 1032 include a projection 1058 that extends from the end surface and into the corresponding through-hole 1054 (FIG. 30) to laterally interlock the reinforcement layer 1022 with the anode FF plate 1016.

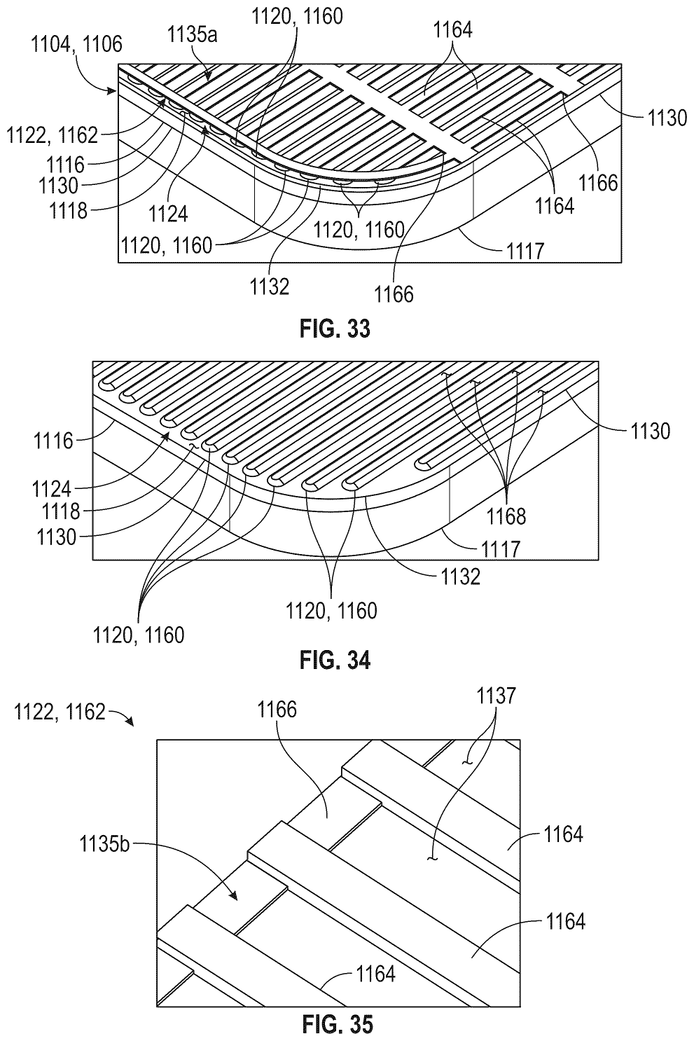

Referring to FIGS. 33-35, another example of an anode FF plate assembly 1106 (assembly) is similar to the assembly 106 of FIGS. 3-5. As with previous Figures, to avoid undue repetition, elements in the implementation of FIGS. 33-35 that are analogous to elements shown in FIGS. 3-5 are called out with numbers that share the same last two digits as those analogous elements in FIGS. 3-5. Thus, the discussion provided above with respect to the elements of FIGS. 3-5 will be understood to be equally to the analogous elements in FIGS. 33-35 unless indicated otherwise. In the interest of conciseness, discussion of these elements that would be redundant of earlier discussion herein of similar elements is not provided, with the understanding that the earlier discussion of such elements is applicable to these similar elements in FIGS. 33-35.

While the raised features 120 of FIGS. 4 and 5 are the dimples 126 distributed across the floor surface 118, the raised features 1120 of FIGS. 33 and 35 are a plurality of straight channel walls 1160 that have a predetermined thickness and are arranged parallel to one another. Furthermore, while the reinforcement layer 122 of FIGS. 4 and 5 is the support lattice 134, the reinforcement layer 1122 of FIGS. 33 and 35 is a grating 1162 having a plurality of bar portions 1164 and a plurality of crossmember portions 1166 interconnecting the bar portions 1164. At least some of the bar portions 1164 (e.g., each of the bar portions 1164) are supported by the raised features 1120 of the anode FF plate 1116. The grating 1162 may be a single-piece component including the bar portions 1164 and the crossmember portions 1166, with the bar portions 1164 being positioned non-parallel (e.g., perpendicularly) to the crossmember portions 1166. The bar portions 1164 and the crossmember portions 1166 of the grating 1162 distribute a load across the PTL when the PTL is pressed against the anode FF plate 1116. The bar portions 1164 and the crossmember portions 1166 of the grating 1162 are configured to decrease an intrusion of the PTL into the one or more flow fields 1124 when the PTL is compressed towards the FF plate 1116 (e.g., with a pressure up to 400 psi).

At least some portions of the grating 1162 (e.g., the bar portions 1164) act to elevate other portions (e.g., the crossmember portions 1166) away from the floor surface 1118 so as to define a flow field depth. The bar portions 1164 and the crossmember portions 1166 may be flush on a first side 1135a of the support lattice 1134, and the bar portions 1164 may protrude beyond the crossmember portions 1166 on a second side 1135b (FIG. 35) that contacts the anode FF plate 1116. At least some of the bar portions 1164 (e.g., each one of the bar portions 1164) may have a first thickness (e.g., 200 μm) along a longitudinal direction orthogonal to the anode FF plate 1116, and at least some of the crossmember portions 1166 (e.g., each one of the crossmember portions 1166) may have a second thickness (e.g., 100 μm) along the longitudinal direction, with the first thickness of the bar portions 1164 being greater than the second thickness of the crossmember portions 1166. In this example, the first thickness of the bar portions 1164 may be at least twice the second thickness of the crossmember portions 1166. In other examples, the thickness of at least some of the bar portions may be above or below 200 μm, and the thickness of at least some of the crossmember portions may be above or below 100 μm. In other examples, where the crossmember portions may act to elevate the hub portions above the floor surface of the anode FF plate, the thickness of at least some of the crossmember portions may be greater than the thickness of at least some of the bar portions.

At least some of the bar portions or crossmember portions are each diffusion bonded, welded, or otherwise fused or bonded to the raised features 1120 to prevent the grating 1162 from moving in a direction parallel to the floor surface 1118 of the anode FF plate 1116. At least some of the raised features 1120 are a plurality of hydroformed features or a plurality of stamped features that define a plurality of parallel channels 1168. The anode FF plate 1116 may be made of titanium. The anode FF plate 1116 may have a predetermined thickness up to 200 μm. The flow field depth may be at least 320 μm. In one example, at least some of the bar portions 1164 are diffusion bonded, welded, or otherwise fused or bonded to the raised features 1120 positioned at the edges 1130 or the corners 1132 of the anode FF plate 1116. In other examples, at least some of the bar portions (e.g., the bar portions at the corners of the grating, the bar portions at the edges of the grating, and/or the bar portions spaced inward from the corners and edges of the grating, etc.) may be diffusion bonded, welded, or otherwise fused or bonded to the corresponding raised features of the anode FF plate. In some implementations, the reinforcement layer 1122 may be made of a corrosion-resistant, conductive pure valve metal (e.g., titanium, titanium alloy, niobium, tantalum, zirconium, tungsten, etc.). In still other implementations, the reinforcement layer 1122 may be made of a transition metals (e.g., stainless steel, nickel, copper, carbon-based materials, etc.) and an inert conductive coating to protect against corrosion.

For any of the preceding examples in which the laterally interlocking features are positioned at the corners, other implementations can have only a few interlocking features at other locations, e.g., at one or more portions at the edges, near the center, etc. In still other example, one or both of the reinforcement layer and the anode FF plate may not have any interlocking features as integral parts thereof.

For the purposes of this disclosure, “at least one of X, Y, . . . , and Z” and “at least one selected from the group consisting of X, Y, . . . , and Z” may be construed as X only, Y only, . . . , Z only, or any combination of two or more of X, Y, . . . , and Z, such as, for instance, XYZ, XYY, YZ, and ZZ. As used herein, the term “and/or” includes any and all combinations of one or more of the associated listed items.

Although the terms “first,” “second,” “third,” etc., may be used herein to describe various elements, these elements should not be limited by these terms. These terms are used to distinguish one element from another element. Thus, a first element discussed below could be termed a second element without departing from the teachings of the disclosure. To this end, use of such identifiers, e.g., “a first element,” should not be read as suggesting, implicitly or inherently, that there is necessarily another instance, e.g., “a second element.” Further, the use, if any, of ordinal indicators, such as (a), (b), (c), . . . , or (1), (2), (3), . . . , or the like, in this disclosure and accompanying claims, is to be understood as not conveying any particular order or sequence, except to the extent that such an order or sequence is explicitly indicated. For example, if there are three steps labeled (I), (ii), and (iii), it is to be understood that these steps may be performed in any order (or even concurrently, if not otherwise contraindicated), unless indicated otherwise. For example, if step (ii) involves the handling of an element that is created in step (i), then step (ii) may be viewed as happening at some point after step (i). In a similar manner, if step (i) involves the handling of an element that is created in step (ii), the reverse is to be understood.

The term “between,” as used herein and when used with a range of values, is to be understood, unless otherwise indicated, as being inclusive of the start and end values of that range. For example, between 1 and 5 is to be understood as inclusive of the numbers 1, 2, 3, 4, and 5, not just the numbers 2, 3, and 4.

As used herein, the singular forms, “a,” “an,” and “the” are intended to include the plural forms as well, unless the context clearly indicates otherwise. It is also to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in itself, as necessarily encompassing a plurality of items—it is to be understood that a set or a subset can encompass only one member or multiple members (unless the context indicates otherwise). Moreover, a subset may include all of the members of a set. In addition, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatuses of the disclosed embodiments. Accordingly, embodiments are to be considered as illustrative and not as restrictive, and embodiments are not to be limited to the details given herein. To this end, it should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure.

1. A flow field plate assembly for an electrochemical cell of an electrochemical cell system, the flow field plate assembly comprising:
a flow field plate (FF plate) having a floor surface and a plurality of raised features protruding from the floor surface; and
a support lattice having a plurality of hub portions and a plurality of beam portions interconnecting the hub portions, with at least some of the hub portions being supported by the raised features of the FF plate; and
wherein the raised features of the FF plate are distributed across the floor surface, and the hub portions of the support lattice and the raised features of the FF plate space apart the beam portions from the floor surface so as to define a flow field depth.

2. The flow field plate assembly of claim 1, wherein the hub portions and the beam portions are flush on a first side of the support lattice facing away from the floor surface of the FF plate, and the hub portions protrude beyond the beam portions on a second side of the support lattice that contacts the raised features of the FF plate, such that the hub portions act to elevate the beam portions away from the floor surface of the FF plate.

3. The flow field plate assembly of claim 1, further comprising a porous transport layer (PTL), wherein the hub portions and the beam portions of the support lattice are configured to distribute a load across the PTL and decrease an intrusion of the PTL into the one or more flow fields when the PTL is compressed towards the FF plate.

4. The flow field plate assembly of claim 3, wherein at least some of the hub portions of the support lattice are laterally interlocked with corresponding ones of the raised features of the FF plate to prevent the support lattice from moving in a direction parallel to the floor surface of the FF plate.

5. The flow field plate assembly of claim 4, wherein at least some of the hub portions of the support lattice define a hole that is a through-hole, a recess, a cavity, or an opening, and at least some of the raised features each include a pin extending from the floor surface of the FF plate and into the corresponding hole.

6. The flow field plate assembly of claim 5, wherein at least some of the pins terminate at a tapered tip that extends into the corresponding hole of the hub portions.

7. The flow field plate assembly of claim 5, wherein at least some of the pins have an end surface that faces the support lattice and a projection that extends from the end surface and into the corresponding hole.

8. The flow field plate assembly of claim 5, wherein the corresponding hole is a through-hole, a recess, a cavity, or an opening.

9. The flow field plate assembly of claim 5, wherein the support lattice has a polygonal shape with a plurality of corners and a plurality of edges extending between the corners, and the hub portions include a first set of hub portions that are positioned adjacent to the edges or the corners and include the corresponding holes.

10. The flow field plate assembly of claim 9, wherein the hub portions further include a second set of hub portions that are spaced inward from the edges and the corners and do not include the corresponding holes.

11. The flow field plate assembly of claim 9, wherein the hub portions further include a second set of hub portions that are spaced inward from the edges and the corners and include the corresponding holes.

12. The flow field plate assembly of claim 4, wherein at least some of the raised features terminate at an end defining a hole that is a through-hole, a recess, am opening, or a cavity, and at least some of the hub portions of the support lattice include a projection extending into the corresponding hole of the raised features.

13. The flow field plate assembly of claim 4, wherein at least some of the hub portions are each diffusion bonded, welded, or otherwise fused or bonded to a corresponding one of the raised features.

14. The flow field plate assembly of claim 4, wherein at least some of the hub portions are each diffusion bonded, welded, or otherwise fused or bonded to a corresponding one of the raised features that are positioned adjacent to an outside edge of the FF plate.

15. The flow field plate assembly of claim 4, wherein at least some of the hub portions are each diffusion bonded, welded, or otherwise fused or bonded to a corresponding one of the raised features.

16. The flow field plate assembly of claim 15, wherein each one of the hub portions is diffusion bonded, welded, or otherwise fused or bonded to a corresponding one of the raised features, with such couplings between those hub portions and those raised features being positioned throughout the FF plate.

17. The flow field plate assembly of claim 4, wherein at least some of the raised features include a mesa feature.

18. The flow field plate assembly of claim 4, wherein the support lattice includes the hub portions distributed in a repeating pattern, a two-dimensional array, a triangular lattice pattern, or a square lattice pattern.

19. The flow field plate assembly of claim 4, wherein at least some of the hub portions are a joint connected to at least four other hub portions by a corresponding one of at least four beam portions.

20. The flow field plate assembly of claim 19, wherein each of the beam portions has a common length, and the beam portions are angularly spaced apart from one another by a common angle.

21. The flow field plate assembly of claim 19, wherein each of the joints is connected to eight other hub portions by a corresponding one of eight beam portions.

22. The flow field plate assembly of claim 21, wherein four of the eight beam portions have a first common length, and the other four of the eight beam portions have a second common length that is longer than the first common length.

23. The flow field plate assembly of claim 19, wherein the beam portions are angularly spaced apart from one another by a common angle.

24. The flow field plate assembly of claim 1, wherein the support lattice is configured to decrease the intrusion of the PTL into the one or more flow fields when the PTL is compressed towards the FF plate with a pressure up to 400 psi.

25. The flow field plate assembly of claim 1, wherein the raised features of the FF plate are a plurality of hydroformed features or a plurality of stamped features.

26. The flow field plate assembly of claim 1, wherein the FF plate is made of titanium and has a predetermined thickness up to 200 μm, and the flow field depth is at least 320 μm.

27. The flow field plate assembly of claim 1, wherein at least some of the hub portions have a first thickness along a longitudinal direction orthogonal to the FF plate, and at least some of the beam portions have a second thickness along the longitudinal direction, with the first thickness of the hub portions being greater than the second thickness of the beam portions.

28. The flow field plate assembly of claim 1, wherein the support lattice is made of a corrosion-resistant conductive pure valve metal or a transition metal, wherein the corrosion-resistant conductive pure valve metal is at least one of titanium, titanium alloy, niobium, tantalum, zirconium, and tungsten, and wherein the transition metal has an inert conductive coating and includes at least one of stainless steel, nickel copper, and a carbon-based material.

29. A flow field plate assembly for an electrochemical cell of an electrochemical cell system, the flow field plate assembly comprising:
a flow field plate (FF plate) having a floor surface and a plurality of raised features protruding from the floor surface; and
a grating having a plurality of bar portions and a plurality of crossmember portions interconnecting the bar portions, with at least some of the bar portions being supported by the raised features of the FF plate; and
wherein the raised features of the FF plate are distributed across the floor surface, and the bar portions of the grating and the raised features of the FF plate space apart the crossmember portions from the floor surface so as to define a flow field depth.

30.-45. (canceled)
